(19) United States
(12) Patent Application Publication
(10) Pub. No.: US 2007/0118239 A1
(43) Pub. Date: May 24, 2007

(54) Registration and scoring system for sports competition

(76) Inventors: Mary Ashley Zimmermann, Boston, MA (US); David Joseph Saraceno, Newton, MA (US)

Correspondence Address: ALIX YALE & RISTAS LLP, 750 MAIN STREET, SUITE 1400, HARTFORD, CT, 06103, US

(21) Appl. No.: 11/260,954

(22) Filed: Oct. 27, 2005

(51) Int. Cl. G06F 19/00

(52) U.S. Cl. 700/92

(57) ABSTRACT

A computerized system and associated process has a centralized data storage and processor, for receiving and transmitting data over a global communications network. The data storage comprises a plurality of distinct data content including names of competitors and associated personal information, names of horses and associated biographical or medical information, the results of completed equestrian competitions including names and scores for each such competition, the names of at least one future competition, and a standard data entry form by which competitors for a particular future competition can register. A program is also provided for communicating directly or indirectly over the global communications network, with judging computers at a competition. A program is associated with the judging computers for receiving and processing scores from the judges and associating such scores with the identified competitor immediately upon completion of such competitor's event at the competition. Machine-readable media identifying an individual competitor, are attachable to the competitor immediately before the competitor begins a particular event at a competition. The event gatekeeper and judges computers read the competitor's unique identification as attached to the competitor, immediately before the competitor begins the event. Thus, a competitor can register for a competition remotely, the gatekeeper's and judges can identify which competitors participate in particular events immediately before the competitor begins such events, and the results of each event and the entire competition are automatically uploaded to the central data storage means for access by all authorized persons.

### BACKGROUND OF THE INVENTION

The present invention relates to contestant registration performance and scoring in competitive activities, and in particular, to equestrian and similar competitions where a plurality of competitors register in advance for entering one or more events in each of a plurality of competitions on different days sponsored or sanctioned by a central governing authority.

Amateur equestrian events in the United States and other countries are run by many local organizations under the loose authority of one or two central governing bodies. Notwithstanding the significant amount of information that must be recorded and communicated among the various competitors, event organizers, judges, and sanctioning bodies, the information generated or used by each of these entities is at present entered and communicated, by written forms. Thus, the entire process is very labor intensive, especially from the point of view of the competitor. In particular, the current registration process for competitors involves multiple forms, which are often repetitive in nature. These forms are sometimes misdelivered via traditional mail or misplaced within the office of the local sponsor of the competition.

The overall process includes advance registration, checking-in, judging, billing of participation fees after the event, and posting of results. Registration is typically by paper using forms that are different for each competition. Similarly, the judging cards by which the competitors are evaluated for each event they have entered are not uniform from competition to competition. Because competitors often register for multiple events at a given competition, but for a variety of reasons may add or scratch at ringside, considerable confusion arises in subsequent billing as to whether a competitor actually performed in a particular event.

Furthermore, due to the delays associated with the current manual posting method, a considerable and frustrating lag time arises throughout the competition season between the completion of a particular event or competition and the availability to competitors (and even the governing body) of the cumulative points awarded to each competitor. Thus, the point standings for year-end results and associated year-end awards are often miscalculated.

Presently, there is no way for competitors to access the relevant information from all of the competitions, from a single source. Such information includes the contestants who have registered for a particular competition, results of the competition, the point standings, and the like. Although this kind of information is eventually accumulated by a governing body, such as the United States Association of Equestrians (USAE), the information is not readily available to all other interested parties who are directly involved in the competition.

### SUMMARY OF THE INVENTION

It is, accordingly, an object of the present invention to automate and integrate the pre-competition registration, the competitor identification, participation and scoring for each event at a given show or competition, and the immediate communication of the scoring to the sanctioning body and other interested parties.

In accordance with the present invention, a computerized system and associated process has a centralized data storage and associated processor, for receiving and transmitting data over a global communications network, such as the internet. The data storage means comprises a plurality of distinct data content including names of competitors and associated personal information, names of horses and associated biographical or medical information, the results of completed equestrian competitions including names and scores for each such competition, the names of at least one future competition, and a standard data entry form by which competitors for a particular future competition can register. A computer program is provided for communicating with a multiplicity of competitors over the global communications network for enabling a competitor to access the competitor's biographic data, the competitor's equestrian data, the competitor's competitive results, and the standard registration form, whereby the accessed data can be entered, displayed, or revised. Program means are also provided for communicating directly or indirectly over the global communications network, with judging computers at a competition, whereby the results of the competition are uploaded to the central data storage facility. A program is associated with the judging computers for receiving and processing scores from the judges and associating such scores with the identified competitor immediately upon completion of such competitor's event at the competition. Machine-readable means identifying an individual competitor, such as an adhesive bar code or the like, are attachable to an individual competitor immediately before the competitor begins a particular event at a competition. Means are coupled to the judge's computer for reading the competitor's unique identification as attached to the competitor, immediately before the competitor begins the event. Thus, a competitor can register for a competition by filling out a form remotely over the global communications network, the judges can identify which competitors participate in particular events of the competition by means of reading the competitor's unique identification immediately before the competitor begins such events, and the results of each event and the entire competition are automatically uploaded to the central data storage means for access by all authorized persons.

The centralized data storage means according to the invention can reside with the governing body, or with a third party administrator working in cooperation with the governing body. This coordination integrates two major aspects of the invention. First, this internet web site enables the competitors to interactively enter and display various data associated with registration, points standing, schedules, and other details associated with particular competitions or events. Second, at such competitions, a barcode, scanning, or similar information gathering system linked to the web site can identify each competitor in an event and the scores of the judges for each event for processing and storage at the central web site for use by the governing body and for access by the competitor following the competition.

The present invention streamlines the equestrians competition industry, as well as any other similar competition industries, by unifying all horse show processes and providing single source access to participants. The barcode or similar data gathering at the competition permits same day data information transfer to all authorized parties. In particular, horse show results and other information can automatically be transferred via a computerized judging “card”, along with the scanned barcode information on each exhibitor, to the web site and thus the governing body for virtually immediate access by any member of the governing body via internet access.

The system and process of the present invention can revolutionize the horse show industry by eliminating the very labor intensive steps which sometimes produces miscalculation of horse show results and therefore point standing, as well as the current time lag in the transmission of results. Elimination of the paper forms as substituted by online entries/registration and online access to exhibitor information, as well as unified judging cards, avoids discrepancies between forms at different horse shows, and provides both rapid and fairer competition results.

### BRIEF DESCRIPTION OF THE DRAWINGS

The preferred embodiment of the invention will be described below with reference to the accompanying drawings, in which:

FIG. 1 is an overview schematic of the system and associated process according to the invention, which encompasses four main components that are integrated automatically via digital computer communications;

FIG. 2 is a representation of a horse/rider registration form usable with the invention;

FIG. 3 is a representation of one form of membership card by which a competitor can log into the horse show office at the day of the competition;

FIG. 4 is a representation of a “number” worn by a competitor with attached bar code; and

FIG. 5 is a representation of a standardized judging card usable with the invention.

### DESCRIPTION OF THE PREFERRED EMBODIMENT

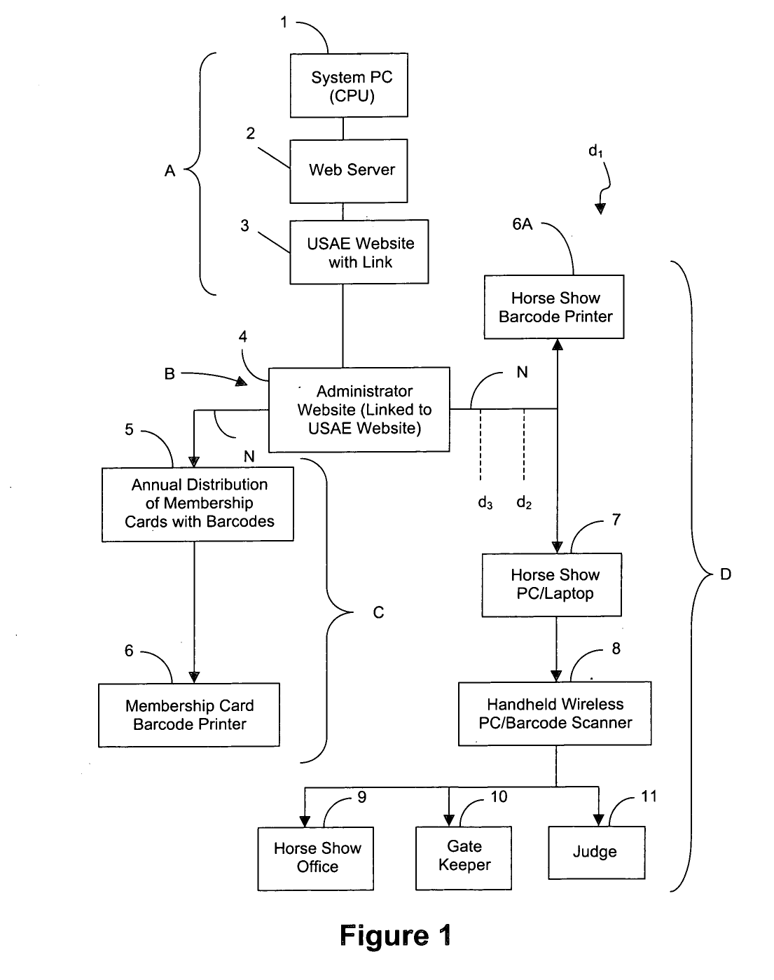

FIG. 1 is an overview schematic of a system for implementing one process embodiment according to the present invention. The system encompasses four main components that are integrated automatically via digital computer communications. The first component A is physically located at the governing body facility (e.g., USAE) and includes a system computer 1, and associated web server 2 which can be similar to the web server currently in place and operated by the USAE. The USAE web site has a link 3 to the second major component B, which is the central administrative facility 4. This can be on the same premises as the first major component, or can be remotely connected thereto by the Internet or an Intranet. The third major component C is the collection of individual competitors 5 and their horses with the attributes that are associated with individual competitors. Each competitor may access the administrative center via a global communications network N, such as the Internet. Finally, the fourth major component D is the collection of competitions or horse shows held by a plurality of local organizers under the auspices of the USAE. It can be appreciated that FIG. 1 represents hardware and process steps associated with one of such competitions d₁, but each competition would have a similar arrangement as indicated by the broken lines d₂, d₃, etc.

The administrative web site 4 has a data storage means comprising a plurality of distinct data content including names of competitors and associated personal information; names of horses and associated biographical or medical information; the results of completed equestrian competitions including names and scores for each such competition; the names of at least one future competition; and a standard data entry form by which competitors for a particular future competition can register.

As part of the registration process, it is preferable that the governing body confirm participants' membership, such as on an annual basis, by mailing (or permitting applicants to print out locally) membership cards 5 or the like containing unique barcodes associated with each member. The member (e.g., competitor) can thus in advance of competition, print out 6 one or more scanable stickers containing their barcodes, for the competitor to attach to the competitor's competition number after it has been assigned to them for wearing during a particular judgeable event. The barcode can contain not only the competitor's name but also the membership number, the horses name, or any other information that is typically collected at ringside before a particular event.

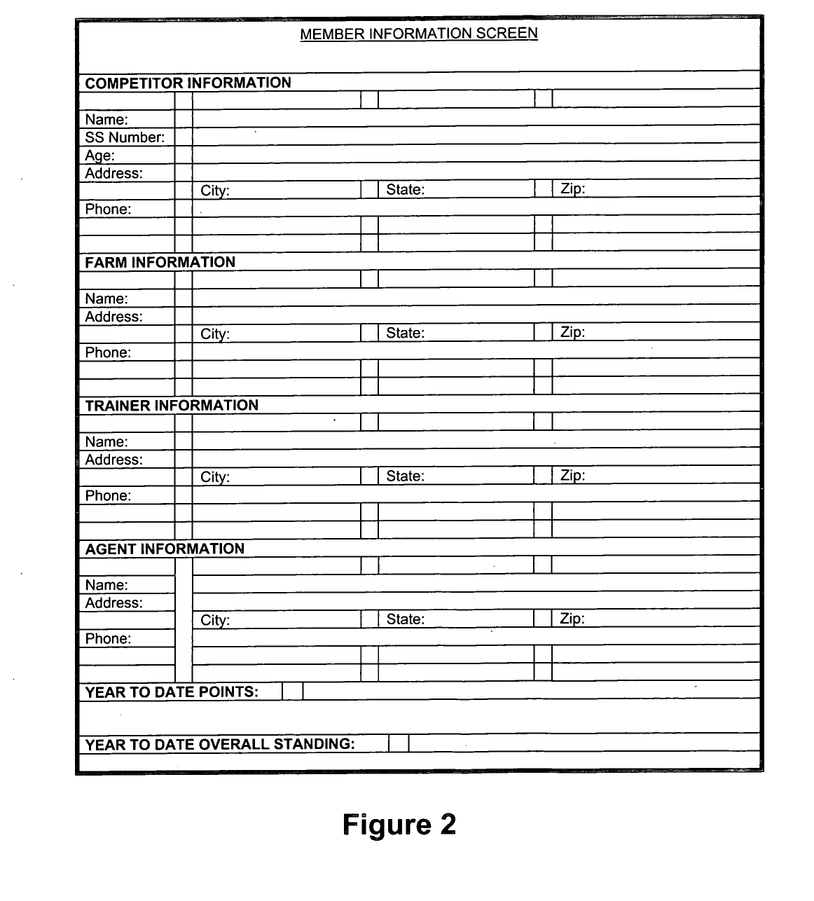

A particular competitor 5 may wish to register for a plurality of events at a plurality of competitions during the season. Rather than registering directly with the organizers of each competition, each competitor can register through the administrative site B by filling out a computerized form and transmitting it over the global communications network N. FIG. 2 is a representation of a horse/rider registration form usable with the present invention for multiple competitions. The form has fields for entry of name, personal identification number (e.g., Social Security or driver's license number), birth date, address, telephone number, farm identification, trainer information, agent information, year to date points, and year to date overall standing. The central administrator can optionally enter the year to date points and year to date overall standing based on previously accumulated data, then forward this information in a coordinated fashion to the organizers of each competition d₁, d₂, d₃ . . . etc. The organizers (and thus eventually the judges) can thus identify which competitors are registered to participate in particular events of the competition.

At a particular competition, the competitor will be assigned a number to be worn on the back or the like. Before attaching the number to clothing, the competitor can place his or her own pre-printed 6 barcode on the substrate associated with the number, for scanning by the judges immediately before entry into the ring. Alternatively, or in addition thereto, the ringside coordinator has a barcode printer 6A that prints out scannable stickers containing the competitor's barcode prepared from competitor data in the office computer stored during registration or pre-registration for attachment to the exhibitors' numbers. These barcodes are scanned at ringside to alert all relevant parties that the exhibitor has entered the ring of competition. This not only includes the judges, but can include public address announcers, or the operator of a large screen display that identifies the competitor or shows a visual of the competitor or horse, etc. The bar code has a subset of the registration information (FIG. 2)

A horse show office administrative computer 7 such as a laptop or other device is connectable to the central administrative computer 4 via the network N for rapid data transfer. This could also be implemented using either Bluetooth® or 802.11b WLAN wireless networking to receive data from wireless barcode scanners. The office computer 7 manages data sent by the handheld barcode scanner 8, and downloads the entry data and other information from the central administrator B. The show data, from e.g., show office 9, event gatekeeper 10, competition results 11 and the like are uploaded, to the central administrative computer. Alternatively, depending on the coordination between the central administrator B and the governing body A, some of the registration and results data could be communicated directly between competitors and the governing body A, and between the local competition D and the governing body A.

The real time entry of data by the horse show coordinator at D via the laptop 7 communicates with the hand held wireless PC/barcode scanner 8, such as a personal digital assistant of a type that combines the function of a wireless barcode scanner and a personal digital assistant. This too can be equipped with either Bluetooth® or 802.11b WLAN capabilities. Various data are recorded and managed concerning the competitor's class, horse, payment of show fees, and the like. Data is sent to the horse show PC 7 to be uploaded to the administrative web site at the conclusion of the show.

A distinct handheld wireless input devices 8 for the laptop 7 is associated with, for example, each of the horse show office 9, the gatekeeper 10, and the judges 11, respectively. Each handheld wireless user inputs data relative to their function, which is then conveyed to the horse show laptop 7. The horse show secretary 9 scans the exhibitor's barcode to access the entrance data, verifies correct information and checks on the billing status of the entrance. The gate keeper 10 scans the rider's barcode sticker affixed to the exhibitor number and lets the judges know which exhibitor has entered the competition ring. Even at the last moment, the competitor can add or scratch from the class at ringside via the gatekeeper, and this information is transferred to the office laptop 9 for updating the billing of competitor. The judge 11 receives information about the individual competitors as they enter the ring, from the gatekeeper 10. The judge inputs the rider's score and the scores are sent to the horse show office laptop 7, which can then be uploaded onto the central administrator web site B for immediate availability of standings, results, and the like.

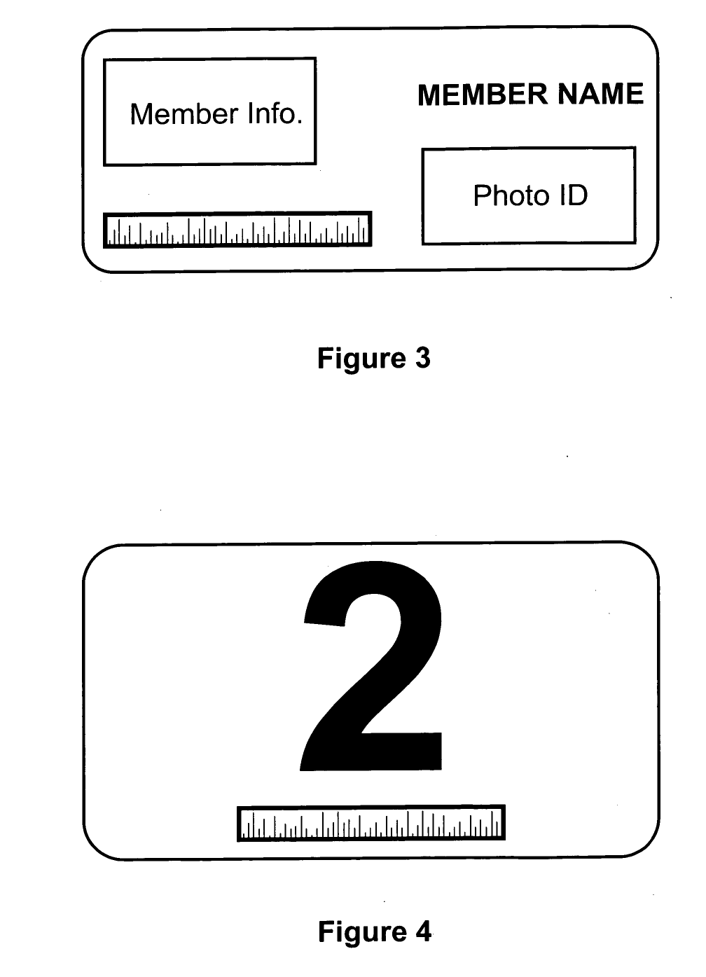

FIG. 3 is a representation of one form by which a competitor can log into the horse show office 9 on the day of the competition, by presenting the membership card with barcode, which is swiped by the secretary thereby calling up all or a subset of the information on the respective competitor that was originally provided upon central registration via the form of FIG. 2. This information would typically be at least the competitor's name, horse, and farm. The rider can be given a numbered vest card or the like at that time, with a duplicate barcode, including rider number, printed out and attached to the rider's card (See FIG. 4 as an example). As noted above, when the rider enters the ring to compete, the bar code from the vest is scanned by the gatekeeper 10. Scanning at ringside will limit billing mistakes by automatically transmitting classes entered into the rider's bill. Scanning at ringside also transmits information about the rider entering the ring to the judge, the show office secretary, and the announcer.

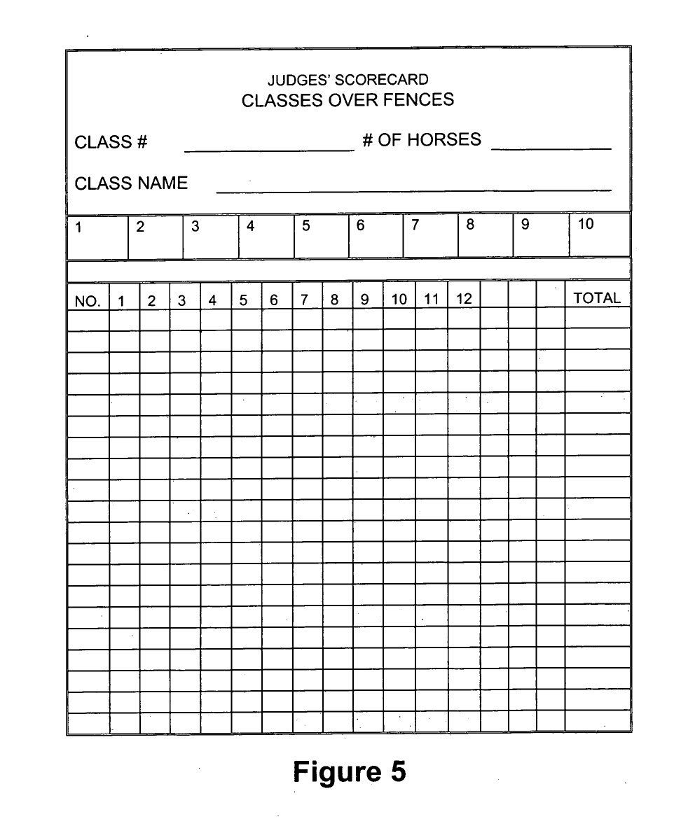

FIG. 5 shows an example of a standard judging card according to the present invention, as would be displayed on a judge's interactive electronic device. The card typically includes the header information for the particular event, and numbered rows and columns corresponding to competitors' numbers and judgable aspects of the event. The judges link via 11, 8 and 7 into the central web site 4 where the results are instantaneously transmitted after each event has been judged. The show office secretary can receive confirmation that the rider actually entered the ring and the bill is automatically updated as the rider enters the ring. Announcer are provided with the rider information on a screen as the rider is scanned entering the ring, given them the availability to announce the rider's information accurately and without confusion in the event a particular rider is added or scratched.

In can be appreciated that with the present invention, the process of equestrian competitions will be tremendously improved through the use of a common reference marker, preferably in the form of a single barcode associated uniquely with each competitor. It will limit errors in recording information, because the information will be transmitted directly from the competitor into the system, and judging results will be transmitted directly from the judges card to the administrative site. The administrative site will automatically update itself to vertically real time results of competitions. The rider information will be entered and stored on the system, given each rider instance access to his or her competition statistics and biographical information. Riders can also access their standings in relation to other competitors. As with other private or semiprivate web site, a authorization sequence will typically be required for every party to log on for accessing information for display, and a higher level of authorization cannot optionally be provided in order to authorize such party to enter data. As a minimum, such authorization would be in the form of a membership number plus a personal password.

1. A computerized system for managing judged competitions among a multiplicity of competitors, comprising:
a central data storage and associated processor, having a communications program for receiving and transmitting data over a global communications network;
the central data storage containing a plurality of stored data including personal information of competitors and a standard data entry form by which competitors can register to participate in particular events in selected competitions;
a central administration program associated with said communications program for communicating with a multiplicity of competitors over the global communications network, enabling a particular competitor to enter that competitor's personal information and register to participate in at least one selected competition;
a computer processing device associated with each of said at least one competition, for receiving from the central administration program, the names of the competitors who have registered in the central data storage means, for participation in said competition;
a media encoding device associated with the central administration program for generating and distributing a membership card for each competitor, containing machine-readable coded information corresponding to at least a subset of the stored personal information;
a device at each of said at least one competitions, responsive to the membership card, for generating coded media containing personal information about said particular competitor, for attachment to an individual competitor immediately before the competitor performs a particular event;
a computer for use by the event judge, including a reader coupled to the judges computer for reading the competitor's coded media attached to the competitor, immediately before the competitor perform the event;
whereby
a competitor can pre register for a competition by filling out a form remotely over the global communications network, and confirm registration at the competition by presenting a coded membership card;
from coded media generated from the coding on the membership card and carried by the competitor into the arena of an event at the competition, a judge for the event can automatically identify the competitors who are registered to participate in a particular event by machine reading the competitor's unique identification immediately before the competitor performs in such event.

2. The system of claim 1, wherein;
the competitions are horse shows;
the central data storage contains the results of completed equestrian competitions including names of participants and scores for each such competition, and a ranking of competitors commensurate with the results of past competitions; and
the central administration program for communicating with competitors permits each competitor to remotely view the scores and the rankings.

3. The system of claim 1, wherein
the competitions are horse shows conducted under the authority of a governing body;
the governing body has a computer system that is in interactive communication with said centralized data storage and associated processor, whereby at least some of the data stored in the data storage are communicated to and stored in the computer system of the governing body.

4. A computerized system for managing judged competitions among a multiplicity of competitors, comprising:
a central data storage and associated processor, having a communications program for receiving and transmitting data over a global communications network;
the central data storage containing a plurality of stored data including personal information of competitors, the names of at least one future competition, and a standard data entry form by which competitors can register to participate in particular events in selected competitions;
a central administration program associated with said communications program for communicating with a multiplicity of competitors over the global communications network, enabling a competitor to enter the competitor's personal information and register to participate in at least one selected competition;
a media encoding device at each of said at least one selected competitions where the competitor has registered, for generating coded media containing personal information about said particular competitor for attachment to an individual competitor immediately before the competitor performs a particular event;
a computer for use by the event judge, including a reader coupled to the judges computer for reading the competitor's coded media attached to the competitor, immediately before the competitor begins the event;
a program associated with the judge's computer for receiving and processing scores from the judges and associating such scores with the identified competitor immediately upon completion of such competitor's event at the competition, and communicating over the global communications network, whereby the results of the competition are uploaded to the central data storage;
whereby
a competitor can register for a selected competition by filling out a form remotely over the global communications network;
the judges can identify which competitors participate in particular events of the competition by means of reading the competitor's unique identification immediately before the competitor begins such events; and
the results of each event and the entire competition are uploaded to the central data storage.

5. The system of claim 4, wherein the coded media is a machine readable bar code for attachment to an individual competitor immediately before the competitor performs a particular event.

6. The system of claim 4, wherein
the competitions are horse shows; and
the central data storage contains the results of completed equestrian competitions including names of participants and scores for each such competition, and a ranking of competitors commensurate with the results of completed competitions.

7. The system of claim 4, wherein
the competitions are horse shows conducted under the authority of a governing body; and
the governing body has a computer system that is in interactive communication with said central data storage and associated processor, whereby at least some of the data stored in the data storage are communicated to and stored in the computer system of the governing body.

8. The system of claim 4, wherein the competitions are horse shows, at least one of which has an office including a computer containing the names of all the competitors who have registered for participation in said competition, a program for communicating over the global communications network and a program for data communications with the judging computers at said competition, whereby the processed scores from the program associated with the judges computers are automatically uploaded from the judges computers to said office computer which communicates said scores to the central data storage.

9. The system of claim 4, wherein the competitions are horse shows and the judges computer includes a program for communicating over the global communications network, whereby the results of the competition are uploaded to the central data storage facility.

10. A computerized system for managing judged equestrian competitions among a multiplicity of competitors who pay a fee for each event they participate in at each competition, comprising:
a central data storage and associated processor, having a communications program for receiving and transmitting data over a global communications network;
the central data storage containing a plurality of stored data including personal information of competitors, the results of completed equestrian competitions including name and scores for each such competition, the names of at least one future competition, and a standard data entry form by which competitors for a particular future competition can register;
a central administration program associated with said communications program, for communicating with a multiplicity of competitors over the global communications network, enabling a competitor to access the competitor's biographic information, the competitor's equestrian data, the competitor's competitive results, and said standard registration form, whereby the accessed data can be entered, displayed, or revised;
at least one of said competitions having an office computer processing device containing the names of all the competitors who have registered for participation in said competition, a program for communicating over the global communications network, and a program for invoicing or debiting competitors said fee for each event in which each competitor participates;
digitally coded media identifying an individual competitor, such as an adhesive bar code or the like, for attachment to an individual competitor immediately before the competitor begins a particular event at a competition;
a gatekeeper device at each event, for machine reading the identifying media for each competitor immediately before the competitor enters the arena to perform the event, and communicating to the office that the competitor has entered the event and should be invoiced or debited the corresponding fee;
a computer for use by the event judge, including a program for communicating with the gatekeeper device to identify the competitor, a program for the judge to enter scores during the performance of the event by the competitor, and a program means for communicating the processed scores to the office computer;
whereby a competitor can register for a competition by filling out a form remotely over the global communications network, the judges can identify which competitors participate in particular events of the competition by reading the competitor's unique identification immediately before the competitor begins such events, the competition office can invoice or debit competitors who participated in particular events of the competition, and the results of each event and the entire competition are uploaded to the central data storage.

11. The system of claim 10, wherein the standard data entry form for registering for a particular future competition is the same form for registering for all competitions through the global communications network or for registering for said future competitions by postal mail.

12. The system of claim 10, wherein each event at a particular competition has a particular judge's form of scorecard, and this form of scorecard is standard for all of the same events at other competitions.

13. The system of claim 10, wherein a plurality of judges score each event on respective judge's computers and the competitor's identification is communicated by the gatekeeper simultaneously to each judge's computer.

14. The system of claim 10, including
a media encoding device associated with the central data storage for generating and distributing a membership card for each competitor, containing machine-readable coded information corresponding to at least a subset of the stored personal information; and
a device at each of said at least one competitions, responsive to the membership card, for generating said coded media containing personal information about said particular competitor, for attachment to an individual competitor immediately before the competitor perform a particular event.

15. The system of claim 10, including a program in communication with the judges computers, for displaying the judges scores to the competitor and audience before the next competitor participates in said event.

16. The system of claim 10, wherein the central data storage includes a current point standings ranking of the competitors who have participated in horse show events during the current season.

17. The system of claim 10, wherein the gatekeeper device is a hand-held wireless device and the judges' computers are hand held wireless devices.

18. The system of claim 10, wherein
the horse shows are conducted under the authority of a central governing body;
the governing body has a computer system at one location that is in interactive communication with said centralized data storage and associated processor operated by an administrator at another location;
whereby at least some of the data stored in the central data storage are communicated to and stored in the computer system of the governing body.

19. The system of claim 10, wherein
the office computer for each competition has competitor registration information received from the centralized central data storage; and
said office computer is connected in the office to a printer responsive to said received registration information, for generating said coded media before the competitor checks into the office.

20. The system of claim 14, wherein
the office computer for each competition has stored competitor registration information received from the central data storage,
a check-in device is provided for reading the competitor's membership card and comparing information on the membership card against at least some of the stored information when the member checks into the office; and
a printer responsive to at least one of the check-in device or said membership card, is provided for generating said coded media.

21. The system of claim 10, including means associated with the central data storage for generating and distributing to each registered competitor a plurality of machine readable coded information tags corresponding to at least a subset of the stored personal information, for attachment by the competitor to a competition number card to create said digitally coded media identifying an individual competitor, before the competitor performs a particular event.
